(19) United States
(12) Patent Application Publication
(10) Pub. No.: US 2006/0293820 A1
(43) Pub. Date: Dec. 28, 2006

(54) Air bag safety demonstration vehicle and method

(76) Inventor: Lawrence G. Hicks, Lacey Springs, AL (US)

Correspondence Address: LANIER FORD SHAVER & PAYNE, P O BOX 2087, HUNTSVILLE, AL, 35804, US

(21) Appl. No.: 11/472,762

(22) Filed: Jun. 22, 2006

Related U.S. Application Data
(60) Provisional application No. 60/692,913, filed on Jun. 22, 2005.

(51) Int. Cl. B60R 22/00

(52) U.S. Cl. 701/45

(57) ABSTRACT

An apparatus and method for an air bag safety demonstration vehicle is claimed. The vehicle provides a simulation of the front seat of an automobile, complete with steering wheel, dashboard simulator, one or more car seats, and one or more seat belts. The vehicle provides for demonstration of a driver's side and passenger's side frontal air bag. The vehicle is used to simulate the dangers of automobile air bags and the criticality of proper seat belt usage to minimize these dangers.

### REFERENCE TO RELATED APPLICATIONS

This application claims priority to Provisional Patent Application U.S. Ser. No. 60/692,913, entitled “Air Bag Safety Demonstration Vehicle and Method” and filed on Jun. 22, 2005, which is fully incorporated herein by reference.

### BACKGROUND

1. Field

The present invention relates generally to an apparatus and method for demonstrating proper safety measures for drivers and passengers of automobiles equipped with air bags. More particularly, the present invention relates to a demonstration vehicle equipped with automobile air bags which are detonated to demonstrate the importance of seat belt use when riding in vehicles equipped with air bags.

2. Background of the Invention

Since 1998, U.S. federal law has required manufacturers of all new passenger cars and light trucks to install frontal air bags in both the driver's and passenger's side of the vehicle. The frontal air bags are typically located in the steering wheel for the driver's side and in the dashboard for the passenger's side. Upon certain frontal impact of the automobile, the air bags automatically inflate, temporarily restraining the driver and passenger and preventing their heads and bodies from striking the steering wheel or dashboard of the vehicle. While the frontal air bags have saved many lives, the air bags have themselves caused many injuries and even deaths, primarily because of failures by individuals to wear their seat belts and by failures of adults to keep children out of the front seat of the vehicle.

Additionally, according to the National Highway Traffic Safety Administration, teenagers have the highest fatality rate in motor vehicle crashes than in any other age group, and a key reason for this high traffic fatality rate is that teenagers have lower safety belt use rates than adults. Safety belts greatly reduce the risk of death or serious injury caused by air bags by restraining passengers as far back from the dashboard (and thus the air bag) as possible.

It would be desirable to have a safety demonstration vehicle that could provide a vivid demonstration of the explosive and dangerous force of a deploying air bag, and would demonstrate how proper seat belt use can prevent air bag injuries. Such a vehicle could be used by schools, law enforcement agencies and other organizations to encourage proper seat belt usage, especially among young people. In addition, it would be desirable to have an economical air bag safety demonstration vehicle that allows for simple and quick removal and replacement of air bags once they have been deployed. The desired demonstration vehicle would be capable of demonstrating both driver's side and passenger side air bag deployment.

### SUMMARY OF THE INVENTION

Therefore, the primary objective of this invention is to provide an air bag safety demonstration vehicle. The apparatus consists of an automobile simulator vehicle including a steering wheel and/or dashboard simulator equipped with one or more air bags and one or more seats with seat belts. During a demonstration of the vehicle, the air bags are detonated to show the dangerous effects of improper seat belt usage on a human body simulator. The vehicle is designed for quick and simple replacement of spent air bags.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

The present invention is described with reference to the accompanying drawings. In the drawings, like reference numbers indicate identical or functionally similar elements.

FIG. 1 is a perspective view of one embodiment of the invention, configured with a driver's side air bag;

FIG. 2 is a perspective view of one embodiment of the invention, configured with a passenger's side air bag.

### DETAILED DESCRIPTION OF THE ILLUSTRATED EMBODIMENT

The present invention and its advantages are best understood by referring to the drawings. The elements of the drawings are not necessarily to scale, emphasis instead being placed upon clearly illustrating the principles of the invention. Throughout the drawings, like numerals are used for like and corresponding parts of the various drawings.

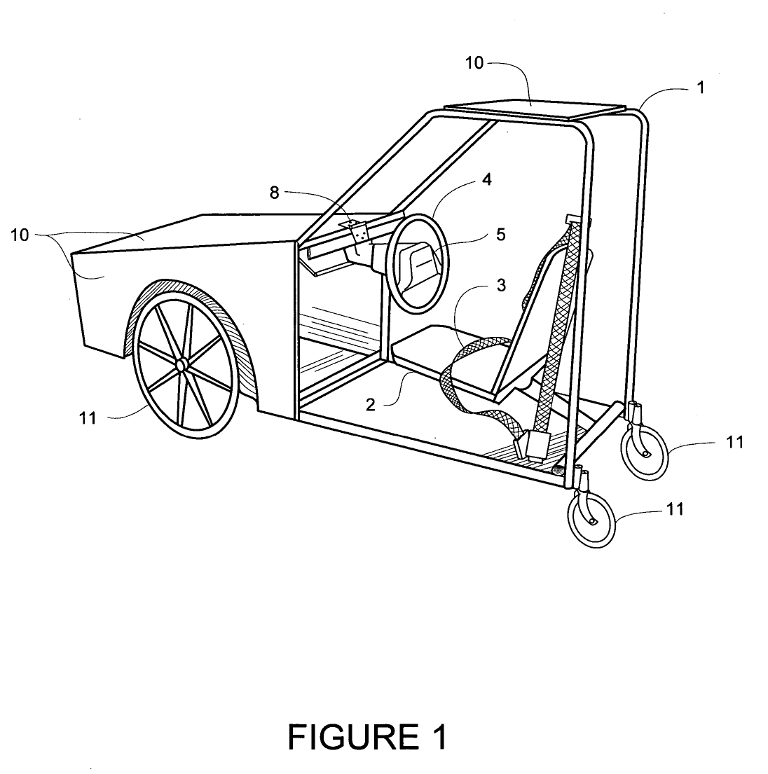

FIG. 1 illustrates one embodiment of the invention. The vehicle chassis 1 consists of a frame made in the shape of the front part of an automobile. The frame can be made of tubing, pipe, lumber, or other materials. Panels 10 represent the hood, roof, and partial side of the vehicle and can be made of any of any number of materials, such as plywood, plastic, or aluminum sheeting. In this embodiment, the vehicle has no doors to allow for better viewing of the air bag safety demonstration. In other embodiments, an actual automobile chassis could be used for the vehicle chassis 1. Wheels 11 provide mobility for the vehicle, though are not required for the demonstration or to practice the invention.

In the illustrated embodiment, the interior of the vehicle chassis 1 contains a seat 2 with seat belt 3 and steering wheel 4. The dimensions of the seat 2 and its spacing from the steering wheel 4 are typical of the interior dimensions of passenger cars and light trucks. This embodiment of the invention includes only one seat 2, as the embodiment is intended to be fairly portable and light-weight. Other embodiments of the invention may include two or more seats, to simulate more realistically an automobile's front seat area.

An air bag 5 is installed into the steering wheel 4 for demonstrations of the effects of air bag deployment. The steering wheel design allows for easy removal and replacement of spent air bags. In demonstrations, the air bag 5 is connected to a power source (e.g., a battery, not illustrated) to detonate the air bag. The power source can be installed within the vehicle chassis 1 or a portable power source can be used to deploy the air bags. Activating the deployment of the air bag through a power source, as compared with activating the air bag by an actual collision, is designated as “static activation” for the purposes of this application.

Safety devices may be used to reduce the risk of injury due to inadvertent deployment. An example of such a safety device is a red light on the vehicle that illuminates when the air bag is “armed” to warn onlookers to keep their distance. The air bags are deployed with a manual switch in one embodiment, and in another embodiment the air bags are deployed by a frontal impact of the vehicle with a wall or other solid object. Some embodiments of the invention may include a motorized vehicle involved in an actual collision for a more realistic demonstration.

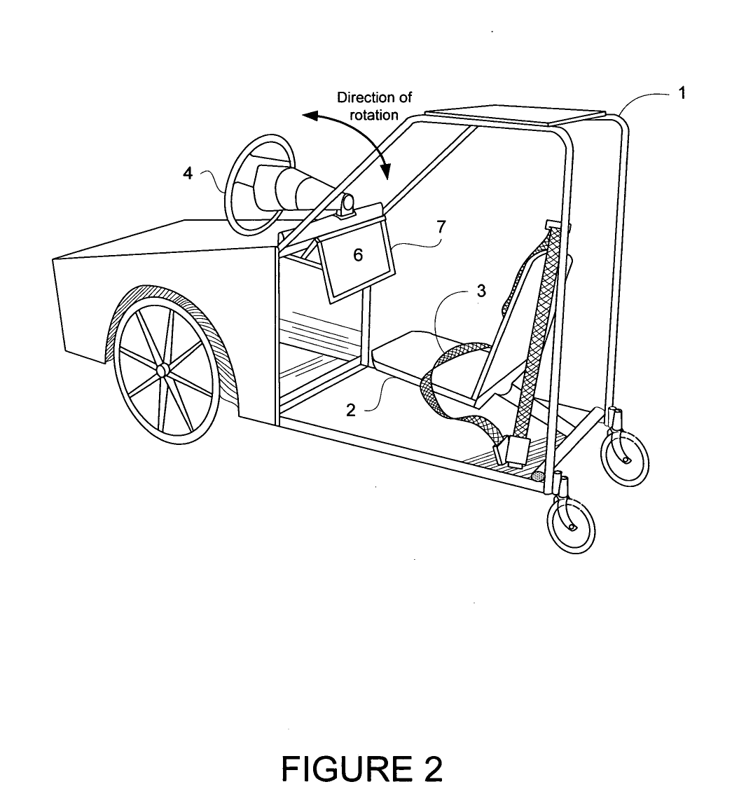

The embodiment of the invention shown in FIG. 2 allows for reconfiguration of the vehicle from a driver's side air bag simulator to a passenger side air bag simulator. The reconfigurable nature of this embodiment allows the vehicle to remain a compact one-seat vehicle and yet still provide an air bag demonstration of both front seats. In this embodiment, the steering wheel 4 is secured to the dashboard of the vehicle with one or more sets of hinges 8 (illustrated in FIG. 1) that allow the steering wheel 4 to be quickly and easily rotated up and outside of the vehicle to reveal a passenger side dashboard simulator 7. A passenger side air bag 6 is installed in the dashboard simulator 7 and is deployed in a demonstration to show the hazards of passenger side air bags, which are generally larger and thus more potentially damaging than driver's-side air bags.

In a typical operation of the air bag safety demonstration vehicle, a human body simulator (not illustrated) is placed into the seat 2. The human body simulator can be as complex as a crash test dummy or as simple as a cardboard box torso with a gallon jug of water for a head. If a seat belt with a shoulder harness is not worn in an automobile crash, the torso will be thrown toward and against the steering wheel or dashboard upon impact as the air bag deploys. In a typical demonstration, the human body simulator is positioned against the steering wheel 5 or dashboard simulator 7 and the air bag is deployed. The explosive force of the air bag deployment will violently push the human body simulator backwards.

Using the embodiment of the invention shown in FIGS. 1 and 2, both the driver's side air bag 5 and the passenger side air bag 6 can be demonstrated. An effective demonstration using the passenger side air bag 6 is to install a child safety seat in the seat 2 facing backwards. In reality, the force of the air bag deploying can dislodge a child from the child safety seat and hurl the child with projectile force. For this reason, adults are warned to never put children in child safety seats in the front seat, and especially not facing backwards. A demonstration of the hazards of not heeding this warning can be performed with the passenger side air bag 6.

This invention may be provided in other specific forms and embodiments without departing from the essential characteristics as described herein. The embodiment described is to be considered in all aspects as illustrative only and not restrictive in any manner. The following claims rather than the foregoing description indicate the scope of the invention.

As described above and shown in the associated drawings and exhibits, the present invention comprises a method and apparatus for an air bag safety demonstration vehicle. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. An apparatus for demonstrating the operation of vehicle air bags, wherein said apparatus comprises
one or more vehicle seats,
one or more air bags positioned a specified distance from the vehicle seat, and
a means for static detonation of the air bags.

2. The apparatus of claim 1, wherein an air bag is installed in a steering wheel and a vehicle seat simulates a driver's side seat.

3. The apparatus of claim 1, wherein an air bag is installed in a dashboard simulator and a vehicle seats simulates a passenger's side seat.

4. The apparatus of claim 1, further comprising
an automobile seat belt with a shoulder harness, whereby the apparatus provides a realistic demonstration of the dangerous effects vehicle air bags can have on the human body unless seat belts are used properly.

5. The apparatus of claim 1, further comprising
a vehicle chassis designed to simulate the front portion of a passenger car or light truck.

6. The apparatus of claim 2, wherein the steering wheel is rotatable up and outside of the vehicle chassis to disclose a dashboard simulator containing an air bag.

7. The apparatus of claim 5, wherein the vehicle chassis provides a generally unobstructed view of the interior of the apparatus.

8. The apparatus of claim 4, further comprising
a human body simulator.

9. An apparatus for simulating the operation of vehicle air bags comprising
a vehicle chassis designed to simulate the front portion of a passenger car or light truck,
at least one vehicle seats,
at least one air bag positioned a specified distance from the vehicle seat,
an automobile seat belt with a shoulder harness,
a means for static detonation of the air bag, and
a human body simulation device,
whereby the apparatus provides a realistic demonstration of the dangerous effects that vehicle air bags can have on the human body unless seat belts are used properly.

10. A apparatus for simulating the operation of vehicle air bags comprising
a vehicle chassis,
one vehicle seat,
an air bag installed into a steering wheel positioned a specified distance from the vehicle seat,
an automobile seat belt with a shoulder harness,
a means for static detonation of the air bag, and
a human body simulation device,
wherein the steering wheel is rotatable up and outside of the vehicle chassis to disclose a dashboard simulator containing an air bag, whereby the apparatus provides a realistic demonstration of the dangerous effects that both driver's side and passenger side vehicle air bags can have on the human body unless seat belts are used properly.

11. A method for demonstrating the dangerous effects that automobile air bags can have on the human body unless seat belts are used properly, comprising the steps of:
a. arranging a human body simulator in a vehicle simulator equipped with one or more air bags;
b. either securing or not securing the human body simulator into the vehicle simulator with a seat belt; and
c. statically detonating the one or more air bags.
